(19) United States
(12) Patent Application Publication
(10) Pub. No.: US 2003/0204716 A1
(43) Pub. Date: Oct. 30, 2003

(54) System and methods for digital content distribution

(76) Inventors: Troy Dean Rockwood, Thousand Oaks, CA (US); Bong Kyun Ryu, Thousand Oaks, CA (US); Wensheng Zhou, Los Angeles, CA (US); Yongguang Zhang, Moorpark, CA (US)

Correspondence Address: Mark D. Elchuk and Elizabeth D. Odell, Harness, Dickey & Pierce, P.L.C., Suite 400, 5445 Corporate Drive, Troy, MI, 48098-2683, US

(21) Appl. No.: 10/131,104

(22) Filed: Apr. 24, 2002

(51) Int. Cl. H04L 9/00

(52) U.S. Cl. 713/150; 705/51; 713/201

(57) ABSTRACT

A system for distributing digital content from a content provider to content presenter(s) for presentation. The system includes a provider apparatus that encrypts the content before distribution thereof and sets at least one condition for presenting the content, and a presenter apparatus to which is distributed the encrypted content and which is allowed to decrypt the content when the at least one condition is satisfied. The system allows for secure distribution of multimedia presentations from one source to geographically separate locations. The system provides for secure presentation and cryptographically secure accounting for each presentation.

### FIELD OF THE INVENTION

The present invention relates to distribution of digital content and, more particularly, to controlling distribution of digital content such as cinematic content to presenters.

### BACKGROUND OF THE INVENTION

Distribution of cinematic content by a cinema content provider to cinema presenters can be problematic for both the content provider and presenters. A presenter typically receives cinematic content via the content provider and/or a distributor. It can be appreciated that security of distribution is important to content providers, who typically strive to prevent unauthorized access to distributed content. Thus, content providers usually require distributors and presenters to protect against such access. When cinematic content is put into digital form and transmitted digitally, however, the possibility can be increased for hackers and others without authorization to succeed in attempts to access such content.

Content providers and presenters also can find it difficult to project an optimal length of time, for example, for showing a particular movie presentation. Depending on the payment arrangement in effect for a particular movie, the presenter and/or the provider might wish to book the movie for showing at a particular theater for so long as the movie proves popular with theater patrons, and to replace the presentation when attendance wanes. The difficulty in forecasting the popularity of a movie hampers both content providers and content presenters in reaching an agreement that ultimately would benefit both parties. Additionally, once a movie has been distributed to a presenter, the provider can find it difficult to verify whether the presenter is meeting its obligations, for example, with respect to presentation scheduling.

### SUMMARY OF THE INVENTION

The present invention, in one embodiment, is directed to a system for distributing digital content from a content provider to at least one content presenter for presentation. The system includes a provider apparatus that encrypts the content before distribution thereof and sets at least one condition for presenting the content. The system further includes at least one presenter apparatus to which is distributed the encrypted content and which is allowed to decrypt the content when the at least one condition is satisfied.

The above-described system allows for the secure distribution and presentation of, for example, cinema-quality multimedia presentations from a single source to a plurality of geographically separate locations. The system allows participants to have various levels of trust with other participants, ranging from complete trust to guarded and limited trust. The system provides for cryptographically secure accounting for each presentation. The system also protects the multimedia content from both eavesdropping, “man in the middle”, and so called “active” attacks.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a diagram of a system for distributing digital content according to one embodiment of the present invention;

FIG. 2 is a flow diagram of operation of a system for distributing digital content according to one embodiment of the present invention; and

FIG. 3 is a flow diagram of operation of a system for distributing digital content according to one embodiment of the present invention.

### DETAILED DESCRIPTION OF THE PREFERRED EMBODIMENTS

The following description of the preferred embodiment(s) is merely exemplary in nature and is in no way intended to limit the invention, its application, or uses.

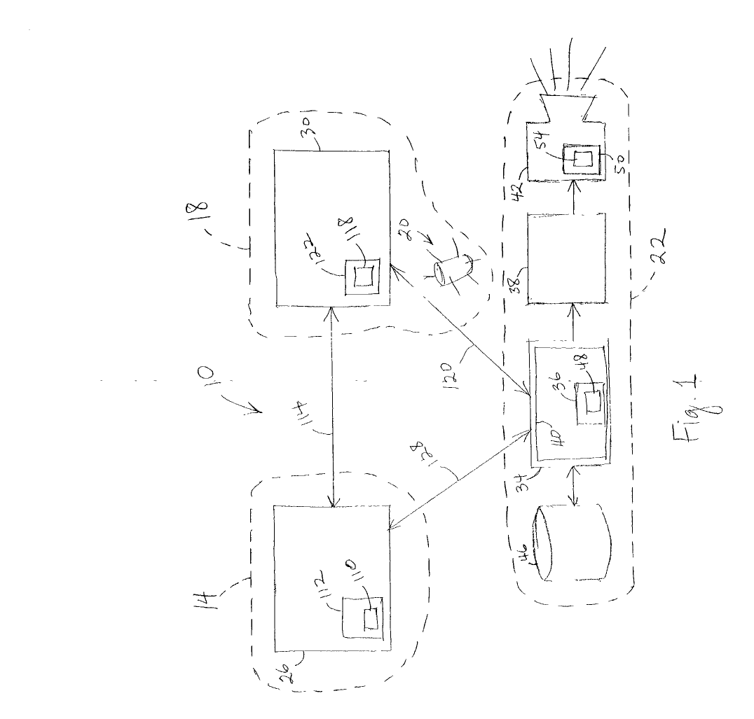

The present invention, in one embodiment, is directed to a system for distributing digital content, indicated generally in FIG. 1 by reference number 10. The system 10 can be used by a content provider to provide digital content to a presenter. For example, a producer of multimedia content can use the system 10 to provide cinematic content in digital form to a plurality of theatres in a plurality of geographic locations. The content is distributed to the theatres, for example, via a satellite network.

It should be understood that although the present embodiment is described in relation to providing digital cinematic content, the invention is not so limited. The present invention can be practiced in connection with distributing various types of data in digital form and/or accounting for the presentation of such data. The terms “data” and “content” are used interchangeably herein and include, but are not limited to, multimedia and textual data. Additionally, although a distribution apparatus is described herein in connection with a satellite network, other digital content transport means can be used in other embodiments of the invention. For example, content transmission could be via the Internet and/or land-based cable such as fiber-optic cable. It also should be understood that references herein to content provider(s), distributor(s) and/or presenter(s) are illustrative and should not be construed to necessitate any particular relationship(s) among user(s) of the embodiments described herein. It is contemplated that embodiments of the present invention could be used by any number of users, including a single user who provides, distributes and presents digital content.

Referring now to FIG. 1, the system 10 includes a content provider apparatus 14 used by the content provider. A distribution apparatus 18 is used by a distributor, for example, an owner and/or operator of a satellite network 20 over which the content is distributed. Each presenter uses a presenter apparatus 22 as further described below. The provider apparatus 14 includes at least one computer or processor 26. The distribution apparatus 18 also includes at least one computer or processor 30. As further described below, the distribution apparatus 18 can authenticate, using strong authentication, communications with the content provider apparatus 14 and can support strong encryption.

The presenter apparatus 22 includes a computer or processor 34, e.g., a general-purpose computer. The computer 34 has access to a content storage area 46. The computer 34 is equipped with a “secure container” 36 wherein a cryptographic key (“presenter key”) 48 may be stored in such a way that it cannot be extracted. One such device is the IBM 4758 cryptographic coprocessor. The computer 34 is also configured to communicate with both the provider apparatus 14 and the distribution apparatus 18, for example, to request keys and other information as further described below. Such communications links can be, for example, private links as known in the art. The computer 34 has a tamper-evident casing 40 whereby it can be determined whether the computer 34 has been opened, for example, in an attempt to access information within it.

The presenter apparatus 22 also optionally includes a decompression unit 38, useful in embodiments in which it is desired to transfer compressed digital content to the presenter apparatus 22. The presenter apparatus 22 also includes a projector 42 having a “secure container” 50 wherein a cryptographic key (“projector key”) 54 may be stored in such a way that it cannot be extracted. The decompression unit 38 decompresses compressed content into a format that can be projected by the projector 42. It is contemplated that other embodiments can include presentation equipment alternative to, or in addition to, the projector 42, for example, computer, television, and audio equipment, depending on the type(s) of data being presented.

The content provider provides content embodied in a digital form transferable between computers as further described below. Unless otherwise described herein, it is contemplated that a function performed, for example, by the provider apparatus 14 and/or the distribution apparatus 18 can be delegated to and/or performed by other computers or processors in place of and/or in addition to computers and/or processors specifically described herein. The terms “computer” and “processor” are used interchangeably in this description and in the claims and can include, but are not limited to, microcomputers, microprocessors, servers, and the like, and also any peripheral device and/or storage area used by a computer or processor.

The content provider may provide an online or offline “menu” of upcoming content transmissions, to inform theater-presenters about new content that is to be available for distribution. Such menu information is transmitted, for example, by the provider apparatus 14 to the presenter apparatus 22 via the Internet and can be digitally signed to prove authenticity. Additionally, the menu may be provided over an authenticated and encrypted path, as further described below, if it is desired to keep such information private. A theatre-presenter may consult the “menu” presented by the content provider to choose content for presentation. The presenter can request, for example, via the presenter apparatus 22, to be included on a list of presenters authorized by the content provider to receive content from the distribution apparatus 18 as further described below.

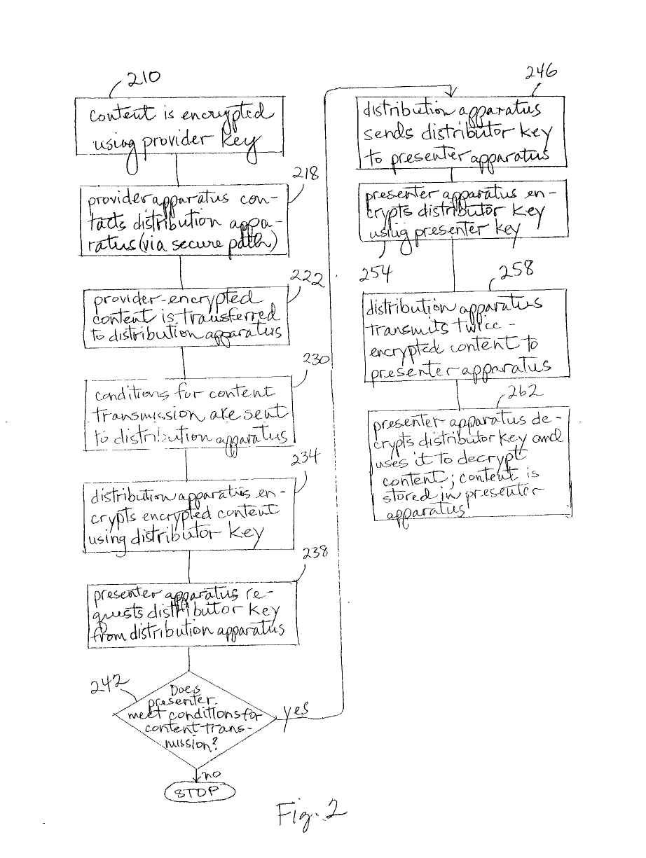

Operation of the system 10 shall now be described with reference to FIGS. 1, 2 and 3. When, for example, the content provider determines that a given digital content is to be made available for distribution via the system 10 to presenters, the content provider, via the apparatus 14, encrypts the content, preferably using symmetric key encryption, at a step 210. Specifically, the content is encrypted with an encryption/decryption key (“provider key”) 110 (shown in FIG. 1) selected by the content provider. Preferably the provider key 110 is stored in a secure computer location 112, for example, where only the content provider can access the provider key 110.

At step 218, the provider apparatus 14 contacts the distribution apparatus 18, for example, via the Internet, preferably over a secure communication path 114 (shown in FIG. 1). Specifically, the path 114 is secure in that it is established between the computers 26 and 30 using strong cryptographic authentication and is encrypted using strong encryption protocol. A plurality of protocols are available for strong authentication and/or encryption, for example, SSL (Secure Sockets Layer) protocol and Internet Protocol Security (IPSec).

After authentication, the encrypted content is transferred from the provider computer 26 to the distribution computer 30 at step 222. Additionally, the content is assigned a unique identifier obtained by performing a cryptographic hash on the encrypted content. One preferred hash algorithm is MD5, developed at RSA Laboratories, Bedford, Mass. The hash is used to identify the content in communications among the provider apparatus 14, distribution apparatus 18 and presenter apparatus 22 as further described below. It is highly preferred that the distribution apparatus 18 not have access to the unencrypted content at any time. The distribution apparatus 18 stores encrypted content received from the provider apparatus 14 in a repository, e.g., the computer 30.

In the present example, the distribution apparatus 18 is to broadcast the content, via the satellite network 20, to a plurality of theatre-presenters at a scheduled broadcast time. Of course, other distribution arrangements are possible including, but not limited to, point-to-point distribution of content by the apparatus 18 to each presenter apparatus 22 at various times. Prior to distributing the content as further described below, the distribution apparatus 18 receives, at step 230, information, from the provider apparatus 14. Such information includes, for example, conditions applicable to presenting the content, such as acceptable content transmission time window(s), list(s) of authorized theater-presenter(s), and content expiry time(s). The distributor may contact the content provider for this information or the content provider may proactively provide this information to the distributor.

The foregoing distribution information preferably is sent from the provider computer 26 to the distributor computer 30 via an authenticated communication path as described herein. The information can be encrypted if it is desirable for the information not to be publicly available. In addition, the provider apparatus 14 can provide combinations of distribution time windows and theater-presenter lists. By way of example, the distribution apparatus 18 could be instructed to distribute a movie with a unique content identifier “12345” to theaters in a group labeled “Kansas Theaters” between June 5 and June 10 and the same movie to theaters in a group labeled “Preview Theaters” between June 1 and June 5.

The distribution apparatus 18, at step 234, encrypts the already encrypted content with another symmetric key (“distributor key”) 118 (shown in FIG. 1) preferably known only to the distributor and stored in a secure computer location 122. The distribution apparatus 18 preferably uses a different key 118 for each encrypted transmission of content to presenters, as shall now be further described.

Prior to broadcast of the content by the distributor apparatus 18, the theater-presenter, via the presenter apparatus 22, contacts the distribution apparatus 18, at step 238, and requests the distributor decryption key 118. At step 242, the distribution apparatus 18 checks whether the presenter meets conditions specified by the provider apparatus 14 at step 230. For example, the distribution apparatus 18 verifies whether the presenter is included in a list of theater-presenter(s) authorized to present the given content. If (and, preferably, only if) the presenter meets the conditions specified at step 230, the distribution apparatus 18, at step 246, transmits the decryption key 118 for the content to the apparatus 22 of the requesting theater-presenter.

The foregoing exchange between the distribution apparatus 18 and the presenter apparatus 22 preferably is via a strongly authenticated and strongly encrypted path 120. After each transmission of a given content to presenter(s) by the distribution apparatus 18, the key 118 used to encrypt that content preferably is purged securely from the location 122. Generally, the distribution apparatus 18 purges content securely from the computer 30 at an applicable expiry time for such content.

When the presenter apparatus 22 has received the distributor key 118, the key 118 is encrypted, at step 254, with the presenter key 48 stored in the secure container 36. The encrypted key 118 is stored, for example, on the content storage array 46. At step 258, the distribution apparatus 18 broadcasts the twice-encrypted content via the satellite network 20. At step 262, the presenter apparatus 22 uses the presenter key 48 to decrypt the key 118 and uses the key 118 to decrypt the broadcast content received from the distribution apparatus 18. The decrypted content (still encrypted, however, with the provider key 110) is stored in the storage array 46. Thereafter, the distributor key 118 preferably is securely purged from the presenter apparatus 22.

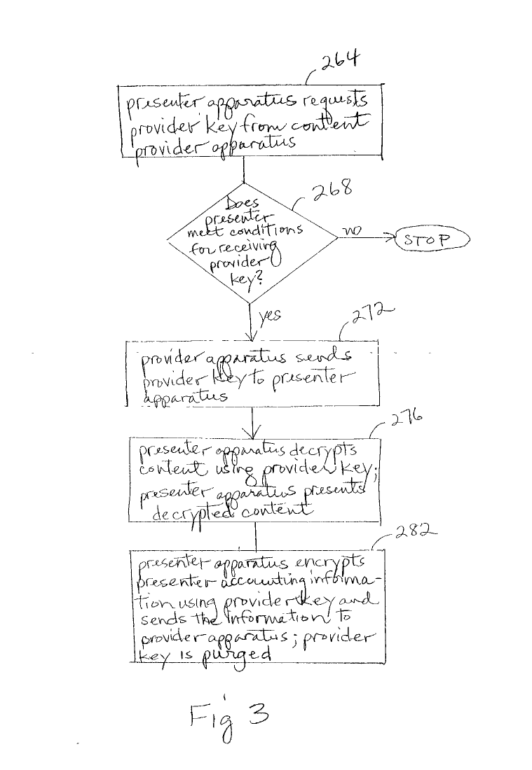

When, for example, the theater-presenter desires to show the content, the system 10 operates as shown in FIG. 3. The presenter apparatus 22 contacts the provider apparatus 14, at step 264, to request the provider key 110 used previously by the provider apparatus 14 to encrypt the content. This communication between the presenter apparatus 22 and provider apparatus 14 preferably is via a path 128 (shown in FIG. 1) that is authenticated using strong authentication and encrypted using strong encryption.

Prior to transmitting the decryption key 110 but after authentication, the content provider can use the provider apparatus 14 to perform several checks at step 268. For example, the presenter, via the presenter apparatus 22, may propose to present the given content at a particular presentation time. The provider apparatus 14 verifies whether the theater-presenter is authorized to present the given content at the proposed time. The content provider can use the apparatus 14 to determine whether such showing would be in compliance with rules established by the content provider for the theatre-presenter, for example, whether the proposed show time falls within a range of show times authorized by the provider as previously described with reference to step 230.

An accounting check also can be made, for example, wherein the provider apparatus 14 evaluates accounting information, received from the presenter apparatus 22 as further described below, relative to any past presentations by the presenter. Other checks to verify theater-presenter integrity may also be performed at step 268. Discrepancies between information given by the presenter apparatus 22 and information maintained by the content provider apparatus 14 could indicate a compromise in security of the presenter apparatus 22. Under such conditions, the content provider apparatus 14 would not send the decryption key 110 to the presenter apparatus 22. If the provider apparatus 14 determines that the presenter apparatus 22 meets applicable conditions for receiving the requested provider key 110, the provider apparatus 14 sends the key 110 to the apparatus 22 at step 272. The transmission of the key 110 preferably is authenticated using strong authentication and encrypted using strong encryption.

The content provider key 110 obtained by the theater-presenter apparatus 22 preferably is not stored on disk and is used as follows. The content is retrieved from the storage array 46 and is decrypted using the provider key 110, as indicated at step 276. The fully decrypted content is optionally decompressed via the decompression unit 38 and presented via the projector 42 as further described below.

The provider key 110 can also be used, as indicated at step 282, to encrypt presenter information for transmission to the content provider apparatus 14. For example, presenter accounting information, including the hash content identifier and presentation time for content being shown, is signed by the computer 34 using the presenter key 48 in the secure container 36. The signed information then is encrypted using the content provider key 110 and is sent to the provider apparatus 14. Thereafter the content provider key 110 preferably is destroyed using a secure purge. The accounting information can thus only be decrypted by the content provider apparatus 14 and cannot be forged if the presenter apparatus 22 is compromised.

Presenter accounting information sent to the content provider apparatus 14 may be used to generate billing records for theater-presenters. Other/additional information can be sent by the presenter apparatus 22 to the provider apparatus 14, for example, information useful to the content provider for determining whether to authorize a previously unscheduled showing of content, as shall be further described below. Generally, the presenter computer 34 checks content expiry times periodically and securely deletes content that has expired.

The decompression unit 38, the computer 34 and the projector 42 preferably operate together at least to the extent that the computer 34 initiates all presentations. It is highly preferred that no presentation can be initiated or replayed except via the computer 34. Communication between the computer 34 and the decompression unit 38 preferably is strongly authenticated and also strongly encrypted, to protect content that passes between the computer 34 and the decompression unit 38 after the content has been decrypted using the content provider key 110.

The projector key 54 is used for authenticating between the computer 34 and the projector 42. In embodiments including the decompression unit 38, the projector key 54 is available to the decompression unit 38 for authenticating both to the computer 34 and the projector 42. Communications into and out of the decompression unit 38 are strongly authenticated and encrypted. In embodiments in which the decompression unit 38 includes a disk drive (not shown), the decompression unit 38 preferably completely and securely purges the drive after each presentation of content. The projector 42 communicates securely with the decompression unit 38 and/or the computer 34. The projector 42 projects streaming content but does not store the content.

In a preferred embodiment, the presenter apparatus 22 contacts the provider apparatus 14, as described with reference to step 264, each time that the presenter desires to present a given content. Thus the system 10 allows the provider apparatus 14 to authorize, at step 272, a presenter apparatus 22 to present content, dependent, for example, on conditions at the time of a proposed showing. If, for example, a theater-presenter sells out of a particular movie showing and desires to hold another showing, the presenter apparatus 22 may request permission from the content provider apparatus 14 and receive authorization to show the movie again based on demand at the theater site. Thus it may be desirable, for example, to reserve one showing room in a theater that is scheduled for presentations based strictly on demand. Where each showing is subject to accounting with the content provider, there is no loss of revenue for this added flexibility. There is, however, a possibility of greater revenue, because the theater-presenter can schedule additional showings in response to customer demand.

In other embodiments, the presenter apparatus 22 can be configured to contact the provider apparatus 14 less frequently than for every showing. For example, the presenter apparatus 22 could be configured to contact the provider apparatus 14 on a daily basis for the provider key 110. Each day the content could be decrypted, stored in decrypted form in the computer 34 or decompression unit 38, and shown one or more times during the day. The decrypted content could then be purged from the computer 34 or decompression unit 38 at the expiration of each day. In yet another embodiment, the content is decrypted only once when received by the presenter apparatus 22, and the apparatus 22 stores the content in decrypted form for so long as the presenter apparatus 22 is authorized to show it. After the last showing of the content, the decrypted content is purged from the presenter apparatus 22.

Authentication is performed in the system 10 using a public key infrastructure (PKI), as known in the art. The PKI is used to manage initial authentication, key and certificate enrollment and renewal as well as key and certificate revocation. The PKI most preferably is controlled by the content provider and preferably is professionally managed. If desired, an additional PKI can be used by the distributor relative to the distribution apparatus 18.

Because the distribution apparatus 18 preferably does not have access to the unencrypted content at any time, accidental or intentional content disclosure by the distributor is virtually eliminated. The distributor does not even need to know the nature of the content, since the distributor acts as a general authentication and transport mechanism. In one embodiment the system 10 is configured to apply watermarks to the content, for use in tracing content “leaks” should a compromise of the content occur.

The foregoing description also illustrates an embodiment of a method for distributing digital content from a content provider to at least one content presenter for presentation. Such method includes encrypting the content using a provider apparatus and a provider key. The content is stored in a presenter apparatus in encrypted form only. The provider key is delivered to the presenter apparatus upon satisfaction of at least one condition set by the provider apparatus 14 for presenting the content.

The system 10 provides for secure distribution of content, e.g. distribution of multimedia presentations over a satellite system, to a plurality of presentation locations located in geographically diverse locations. Presentations of the content can be monitored and authorized by a provider apparatus including a centralized presentation accounting and authorization server. At presentation location(s), the system 10 protects multimedia content from both physical and software-based attacks and attempts to access the content. Thus, for example, the content is protected from unauthorized access by employees of a theater-presenter.

The above system also allows for on-the-fly e-business transactions between content provider and content presenter. Such transaction flexibility has been previously unavailable in arranging for cinema presentations. It is contemplated that on-demand multimedia presentations could be arranged, allowing viewers to take an active role in what productions are presented in theaters.

Because cryptographic techniques are employed to protect the accuracy of accounting activities, the above system is freed from human intervention that would normally be required for continuing business relations between the content provider and the theater. Improved security of the accounting system and the ability to bill dynamically through the system makes it possible for a single contract to cover all presentations from a content provider that will be shown at a theater during the next year.

The above system prevents unauthorized users from accessing the content while allowing authorized users to access content in a transparent way. Thus theater personnel do not need in-depth technical knowledge of cryptography or encryption technology in order to operate the system in a secure manner. The system is designed to have “security in depth.” That is, should one security mechanism fail, e.g. because of erroneous configuration or tampering, other security layers can protect both the content itself and the processes performed on the content. Thus the likelihood for compromise of the content is greatly reduced.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A system for distributing digital content from a content provider to at least one content presenter for presentation, the system comprising:
a provider apparatus that encrypts the content before distribution thereof and sets at least one condition for presenting the content; and
at least one presenter apparatus to which is distributed the encrypted content and which is allowed to decrypt the content when the at least one condition is satisfied.

2. The system of claim 1 wherein the presenter apparatus is configured to store the content only in encrypted form.

3. The system of claim 1 wherein the provider apparatus encrypts the content using a provider key, the presenter apparatus further configured to request the provider key from the provider apparatus before presenting the content.

4. The system of claim 1 further comprising a distribution apparatus configured to distribute the encrypted content from the provider apparatus to the at least one presenter apparatus.

5. The system of claim 4 wherein the distribution apparatus encrypts the encrypted content before distribution to the at least one presenter apparatus, the at least one presenter apparatus further configured to decrypt the encryption by the distribution apparatus upon authorization by the distribution apparatus.

6. The system of claim 4 wherein the distribution apparatus comprises a satellite.

7. The system of claim 4 wherein the distribution apparatus encrypts the content using a distributor key, the presenter apparatus further configured to request the distributor key from the distribution apparatus.

8. The system of claim 4 wherein the distribution apparatus is configured to determine whether a presenter apparatus meets at least one condition for distribution from the provider apparatus.

9. The system of claim 4 wherein the distribution apparatus is configured to store the content only in encrypted form.

10. A system for presentation of digital content from a content provider by at least one content presenter, the system comprising:
a provider apparatus configured to set at least one condition for presenting the content and to encrypt the content using a provider key;
a distribution apparatus configured to encrypt the encrypted content using a distributor key; and
at least one presenter apparatus configured to receive the provider and distributor keys when the at least one condition is satisfied, the at least one presenter apparatus further configured to present the content in decrypted form.

11. The system of claim 10 wherein the distribution apparatus is configured to deliver the distributor key to the presenter apparatus based on at least one condition for distribution received from the provider apparatus.

12. The system of claim 10 wherein the presenter apparatus is further configured to transmit accounting information to the provider apparatus at each presentation of the content.

13. The system of claim 12 wherein the provider apparatus and presenter apparatus are configured to alter a presentation schedule based on the accounting information.

14. The system of claim 10 wherein the provider apparatus comprises a menu of distributable content, the menu accessible by the presenter apparatus.

15. The system of claim 10 wherein at least one of the provider apparatus, the distributor apparatus and the presenter apparatus comprises a secure container for storing a key.

16. The system of claim 10 wherein the presenter apparatus comprises a processor configured to communicate with the provider apparatus and the distribution apparatus.

17. The system of claim 10 wherein the presenter apparatus comprises presentation equipment having a secure container for storing a key.

18. The system of claim 10 wherein the provider apparatus is further configured to deliver the provider key to the presenter apparatus based on at least one of accounting information and content presentation time.

19. A method for distributing digital content from a content provider to at least one content presenter for presentation, the method comprising the steps of:
encrypting the content using a provider apparatus and a provider key; and
storing the content in at least one presenter apparatus in encrypted form;
the method further comprising the step of delivering the provider key to the presenter apparatus upon satisfaction of at least one condition set by the provider apparatus for presenting the content.

20. The method of claim 19 further comprising the step of encrypting the encrypted content using a distributor key, said step performed by a distribution apparatus.

21. The method of claim 20 further comprising the step of delivering the distributor key to the presenter apparatus based on at least one condition communicated by the provider apparatus to the distribution apparatus.

22. The method of claim 20 wherein the step of encrypting the encrypted content using a distributor key comprises receiving the encrypted content via an authenticated path between the provider apparatus and the distribution apparatus.

23. The method of claim 20 further comprising the step of maintaining conditions for delivering the provider and distributor keys, said step performed by the provider apparatus.

24. The method of claim 23 wherein maintaining conditions comprises changing conditions for a presentation when requested by a presenter apparatus at a presentation time.

25. The method of claim 19 wherein the step of delivering the provider key to the presenter apparatus is conditioned on acceptance by the provider apparatus of accounting information relative to the content presenter.

26. The method of claim 25 further comprising the step of submitting presentation times to the provider apparatus, said step performed by the presenter apparatus.

27. The method of claim 26 wherein the step of submitting presentation times to the provider apparatus comprises receiving, from the provider apparatus, a menu of digital content.
